(19) United States
(12) Patent Application Publication
(10) Pub. No.: US 2008/0046130 A1
(43) Pub. Date: Feb. 21, 2008

(54) Agricultural automation system with field robot

(75) Inventors: Stephen Michael Faivre, Kingston, IL (US); Noel Wayne Anderson, Fargo, ND (US); Mark William Stelford, Sycamore, IL (US)

Correspondence Address: DEERE & COMPANY, ONE JOHN DEERE PLACE, MOLINE, IL, 61265, US

(73) Assignee: Deere & Company, a Delaware corporation

(21) Appl. No.: 11/498,392

(22) Filed: Aug. 3, 2006

(51) Int. Cl. G05D 11/00

(52) U.S. Cl. 700/284; 239/728

(57) ABSTRACT

An agricultural automation system for use in an agricultural area includes an implement caddy carrying a plurality of implements, an elongate transport structure, and a field robot movable along the elongate transport structure. The field robot includes an arm movable in at least one direction different from the movement along the elongate transport structure. The field robot interfaces with the implement caddy for coupling the arm with at least one selected implement, such as a tool or sensor.

### FIELD OF THE INVENTION

The present invention relates to agricultural automation systems for use in an agricultural area, such as a field and, more particularly, to agricultural automation systems using robotics to perform tasks and collect data.

### BACKGROUND OF THE INVENTION

Irrigation of agricultural land dates prior to historical records. Some ancient systems simply extended the natural flooding cycles of local rivers, while other systems directed streams into furrows throughout a field to direct moisture to the plants therein. Trickle or drip irrigation is utilized in particularly arid climates to direct small amounts of water to plants to reduce evaporation of the water.

When high pressure delivery systems became available, spray irrigation became popular because the water could be projected to great distances by the pressure created by a drive system. The spray irrigation may additionally utilize machinery that relocates the spray nozzles throughout different portions of the field in a controlled manner. A center-pivot system that traverses a field in a circle includes a transportation system that is driven either electrically or by the water pressure itself. The center-pivot system has a series of nozzles along the length of the irrigation system. Typically a center-pivot system has a number of metal frames or transports that hold a water tube above the canopy of the plants with the frames moving in a circular manner about the pivot. The amount of water applied to any particular area of the field is determined by the rate of travel of the system and the amount of water being delivered to the system. It is not unusual for a center-pivot system to be on the order of 1300 feet long and to irrigate a 130 acre circular area.

Irrigation is one of the major uses of water throughout the world. In the United States it is estimated that an average of 137 billion gallons of water were utilized for irrigation on a daily basis in the year 2000. As the number of acres that are irrigated grows so does the use of water. Water is crucial to the growth of plants and the appropriate application of the water is critical for an efficient use of the irrigation system.

It is also common to add chemicals to the water pumped through the irrigation system. For example, liquid fertilizer and/or insecticides can be drawn into the stream of water which is pumped from a water source such as a river or well. Proper application of the chemicals allows the crops to be grown with a bit more certainty, since nutrient problems and/or insect infestations can be addressed while the crop is growing.

Typically, farmers will examine various aspects of the growing crop to determine the effectiveness of the irrigation system and the need for any maintenance of the irrigation system on at least a daily basis. If the farmer has multiple systems in operation a problem with the system or an attack upon the plants by insects, disease, animals or moisture problems may go undetected for a substantial length of time. The delay in detection may lead to further damage to the crop.

What is needed in the art is an agricultural automation system and method that can efficiently, easily and accurately gather information and perform tasks relating to the irrigation system and the condition of the agricultural crop.

### SUMMARY OF THE INVENTION

The invention comprises, in one form thereof, an agricultural automation system for use in an agricultural area, including an elongate transport structure, and a field robot movable along the elongate transport structure. The field robot is movable in at least one direction different from the movement along the elongate transport structure, and carries at least one implement.

The invention comprises, in another form thereof, an agricultural automation system for use in an agricultural area, including an implement caddy carrying a plurality of implements, an elongate transport structure, and a field robot movable along the elongate transport structure. The field robot includes an arm movable in at least one direction different from the movement along the elongate transport structure. The field robot interfaces with the implement caddy for coupling the arm with at least one selected implement.

The invention comprises, in yet another form thereof, a method of operating an agricultural automation system, including the steps of: moving a field robot along an elongate transport structure in an agricultural area; moving an implement carried by the field robot in at least one direction different from the movement along the elongate transport structure; and performing an agricultural operation with the implement, such as with a tool or sensor.

### BRIEF DESCRIPTION OF THE DRAWINGS

FIG. 1 illustrates an irrigation system with which an embodiment of an agricultural automation system of the present invention is used;

FIG. 2 illustrates another embodiment of an irrigation system with which the embodiment of the field robot of FIG. 1 may be used;

FIG. 3 is a perspective view of the field robot used with the agricultural automation system of FIG. 2; and

FIG. 4 is a flow chart of the agricultural automation method which may be used with the agricultural automation systems of FIGS. 1 and 2.

### DETAILED DESCRIPTION OF THE INVENTION

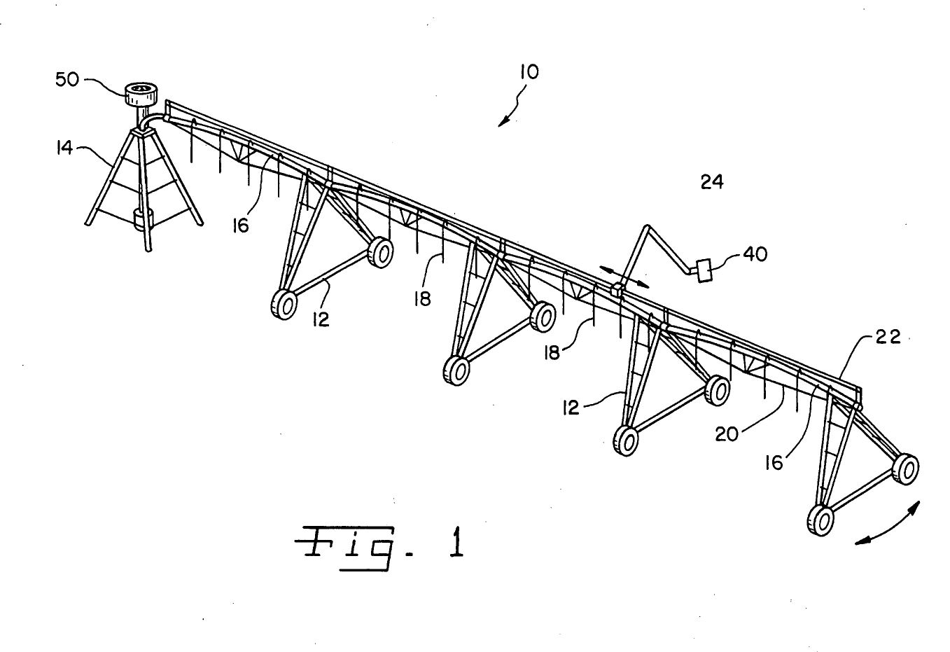

Referring now to the drawings, and more specifically to FIG. 1, there is illustrated an irrigation system 10 having wheeled frames 12 associated therewith. Each frame 12 may be independently driven by a water drive or an electric motor associated therewith, not shown. Even though irrigation system 10 is illustrated and discussed hereafter as a pivot irrigation system, it can be easily understood that the present invention may be applied to any sort of mobile irrigation system. Irrigation system 10 additionally includes a pivot apparatus 14, water delivery pipes 16, nozzles 18, pipe supports 20, an elongate transport structure 22, and a field robot 24.

Pivot apparatus 14 provides a central point about which irrigation system 10 rotates in a circular or circular segment manner. Pivot apparatus 14 additionally has a swivelable pipe system for the delivery of water to water delivery pipes 16. Water travels through delivery pipe 16 in a pressurized manner to nozzles 18 for the expulsion of the water therethrough onto the field below. Nozzles 18 may project the water some distance or basically direct it down upon the crop canopy. Pipe supports 20 typically include rigid structures attached to pipe 16, which are then further supported by cables that traverse the length of each pipe 16 and may be attached to frames 12.

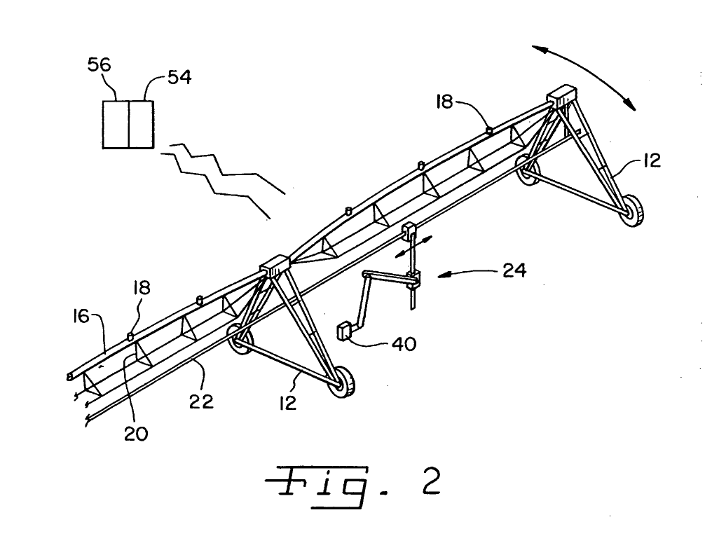

Elongate transport structure 22 is connected to irrigation system 10 along the length thereof. Elongate transport structure 22 may be rigidly supported along pipe 16 or attached to irrigation system 10 in a number of ways. Field robot 24 travels along elongate transport structure 22, which is in the form of a track in the embodiment shown in FIGS. 1 and 2. Irrigation system 10 shown in FIG. 2 is similar to irrigation system 10 shown in FIG. 1, except that the elongate transport structure 22 is positioned below rather than above water distribution pipes 16. It will also be appreciated that elongate transport structure 22 can be configured, e.g. as a cable rather than a track.

Field robot 24 includes a conveyance device 26 for conveying field robot 24 in longitudinal directions 28 along track 22. A power supply positioned therein (not visible) drives conveyance device 26 and powers electrical circuitry within field robot 24. The power supply may be in the form of one or more batteries that may be periodically recharged along track 22. Track 22 may include power charging stations therealong or may supply constant power to field robot 24 along the length thereof. Additionally, an optional solar panel (not shown) may be electrically connected to field robot 24 to provide at least a portion of the power consumed by field robot 24 by way of solar radiation received thereon.

Field robot 24 also includes a displacement apparatus 30 that moves field robot 24 in generally vertical directions 32 along generally vertical rail 34, perpendicular to longitudinal directions 28. Displacement apparatus 30 allows field robot 24 to be lowered beneath the plant canopy to perform a selected sensing or work operation, as will be described below.

Field robot 24 further includes an inboard arm 36, outboard arm 38, and an implement 40. Inboard arm 36 is rotatably coupled with displacement apparatus 30, as indicated by double headed arrow 42. Outboard arm 38 is rotatably coupled with inboard arm 36, as indicated by double headed arrow 44. Of course, the particular configuration and length of arms 36 and/or 38 may vary, depending upon the application.

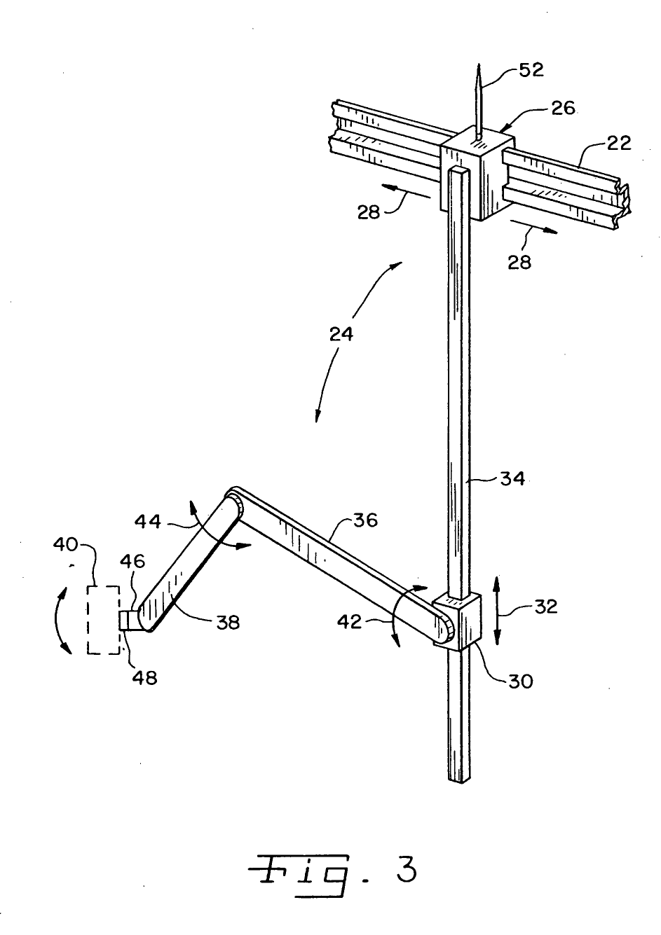

Implement 40 is coupled with the outboard end of outboard arm 38. Implement 40 is shown in dashed lines in FIG. 3, since it may take several different forms, as will be described below. In the embodiment shown, implement 40 is detachably coupled with outboard arm 38. A first quick coupler 46 is attached to the outboard end of outboard arm 38, and a second quick coupler 48 is attached to implement 40. A plurality of implements 40 are stored in an implement caddy 50, which is stationarily positioned on irrigation system 10 near pivot apparatus 14 (FIG. 1). Each implement 40 is attached to a separate quick coupler 48 allowing quick attachment with quick coupler 46 at the end of outboard arm 38.

Field robot 24 may also have all implements constantly on-board. However, due to weight, space, cost, or power constraints, it may be necessary to only have a subset of all implements on field robot 24. Unused implements 40 stored at implement caddy 50 are exchanged by field robot 24 as needed. This type of automatic tool changing is well known for factory robots (e.g., see http://www.ristec.com/define-tc.htm).

Each implement 40 is configured as a tool or a sensor. For example, when configured as a tool, each implement 40 can be a soil probe, a plant sampler, or a clamp-on plant pressure sensor. When configured as a sensor, each implement can be, e.g., a crop sensor, a soil sensor, a weather sensor, an imaging device, or a plant bio-sensor.

Field robot 24 also includes a wireless communication link 52 (with only the antenna being visible in FIG. 3 and the remainder being located within conveyance device 26) which can transmit data from field robot 24 to another wireless communication link 54 of a “back office” computer 56 where data is combined with data from other sources (e.g., weather forecasts, crop model simulation results, business rules, etc.) to generate future missions for the robot and/or actions to be taken by the center pivot system such as irrigation and chemication levels for the area of the field under the pivot. Alternately, this data could be manually offloaded and onloaded to irrigation system 10 using a non-volatile, portable mass storage device, such as a USB memory stick (not shown). In an orchard, horticulture crop, or vineyard application, this field data and back office processing may result in actions taken by humans, other irrigation systems such as drip or tape, or ground robots.

A field robot 24 which is part of a larger field management system including a “back office computer”; pivot speed; water and chemical application rate controllers; and a long range wireless communications link (or less beneficial a USB memory stick style device) has some key benefits.

A mission or sequence of commands may be received by field robot 24 from a remotely located human or the back office computer. The mission may be one of several forms with varying degrees of local autonomy. That is, if certain conditions or met, actions may be taken without further communication from a back office computer or a human. On the other hand, data may be sent to a remote location for analysis and generation of a new mission without any actions being initiated locally.

When used as part of an irrigation control system, field robot 24 can be used to capture crop, soil, and weather information with spatial and temporal resolution that would be too expensive to gather manually. This information, when used with crop and soil models, can be used to generate irrigation prescriptions much more accurately than is currently within economic reach. When irrigation system 10 moves to a new location, field robot 24 can take the following measurements at multiple locations along the irrigation pipe:

Camera images to show any obvious moisture stress;

Soil moisture probes to measure soil moisture at various depths;

Temperature, humidity, sun, and wind ate various heights to more accurately model evapotransiration;

Light sensors and camera images to evaluate vegetative mass, canopy closure, etc.; and/or

Clamp on pressure sensors for measuring stomata closure in response to drought stress.

For nutrient management, an implement 40 in the form of a chlorophyll fluorescence meter such as one made by Hansatech http://www.hansatech-instruments.com/ can provide nutrient deficiency information useful in site-specific chemigation. Alternately, electronic sensors such as NIR for organic matter, soil conductivity, or “mobile wet lab” analysis could be performed.

For horticulture crops, vineyards, and orchards, an implement 40 in the form of a camera providing camera image data can be used to better estimate crop yield, quality, and maturity as color changes occur during ripening (e.g., http://www.ee.byu.edu/roboticvision/linear/papers/Color_Space.pdf#search='image% 20processing%20apple%20maturity'http://www.lib.ksu.edu/depts/issa/china/icets2000/c/c2.pdf#search='image%20processing%20apple%20maturity'; and http://www.gisdevelopment.net/application/agriculture/vield/agrivy0001e.htm). Insect and disease problems may be measured visually using camera image data for possible chemical application.

An implement 40 may also be in the form of a plant bio-sensor using nanotechnology and MEMs technology developments (e.g., see http://en.wikipedia.org/wiki/Biosensor). These can detect spores and other substances associated with pests and diseases long before crops have visual symptoms. Other examples include http://eet.com/news/latest/showArticle.jhtml?articleID=174403473. Earlier detection and treatment of pests and disease are often more effective than a later start to treatment. Similarly, these technologies may drive down the cost and increase the accuracy of soil nutrient sensing. Nutrient data can impact chemical application rates.

If a problem is observed on the crop, an implement 40 in the form of a clipper and grabber can obtain a plant sample and transport it to the central pivot for convenient pick-up by a human. Similarly, soil samples could be collected where problems are observed and transported to the center pivot. A road typically leads from the center pivot to a public road. This is much easier and less labor intensive than driving to a field and then having a human walk through crop to find the spot and collect the sample.

Field robot 24 may also have localization so that data can be georeferenced. GPS is one method. Determining the angle of the pipe relative to north and a distance (landmark, odometry, etc.) of field robot 24 from the center is another method. Other localization methods are known in the art.

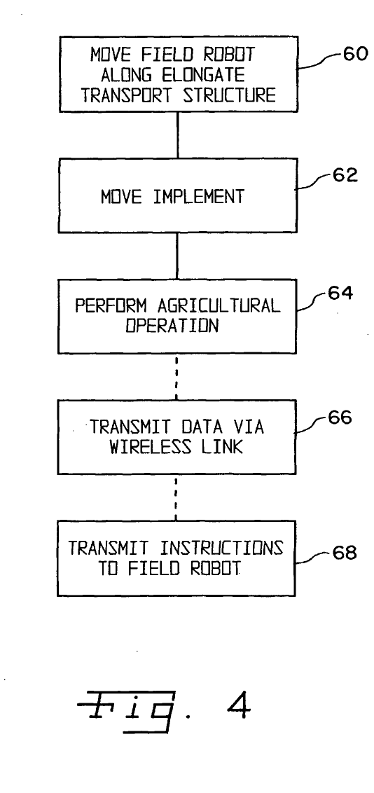

During operation, field robot 24 moves along an agricultural elongate transport structure 22 carried by center pivot irrigation system 10 or on an uppermost member of a plant support trellis such as found in vineyards, tomato fields, and orchards (FIG. 4, step 60). As field robot 24 traverses track 22, data may be gathered in the form of visual information, temperature, etc. Alternatively, irrigation system 10 may be stopped and implement 40 may be moved (step 62) and used to sense parameters or perform a desired work operation (step 64). Field robot traverses track 22 on a predetermined or programmed manner in order to efficiently record data relative to irrigation system 10 as well as the crops in the field. The data gathered is communicated to computer 56 (step 66), which processes the data using algorithms contained therein, which may instruct field robot 24 to be at a selected position at a selected time or at a predetermined position of irrigation system 10 (step 68). Additionally, information processed by computer 56 may be used to communicate instructions to control the travel speed of frames 12 and the water delivery rate of irrigation system 10. Computer 56 may analyze the information received from field robot 24 and provide conclusions, summaries and/or warnings to an operator relative to conditions in the field or of irrigation system 10.

Field robot 24 provides valuable information relative to nozzle operation, robotic operations, monitoring of the soil conditions, crop health, staging of the crop, insect identification, disease identification, information relative to scheduled scans of the crop, production of crop images, varied amounts of information specific to directed targets in the field, atmospheric information, infrared canopy scanning, information relative to pollination of the crop, information relative to stomata closure and other items critical to the growing of plants.

The agricultural automation system of the present invention using field robot 24 reduces labor costs through reduction in human field scouting to get the same or higher resolution of field data. Faster cycle times result since the data is communicated automatically by wireless communication rather than through a human intermediary. Richer data resources at the back office allow the field data to be combined with other data, such as weather history and forecasts, from other sources using algorithms and models that learn and improve over time. Lower system deployment and maintenance costs result from the centralized software with centralized data back-up and archiving, security, processing, etc., which in turn results in lower unit hardware, software, and maintenance costs in the field. More effective water and chemical application result from treatment plans derived from higher resolution, more timely data.

Having described the preferred embodiment, it will become apparent that various modifications can be made without departing from the scope of the invention as defined in the accompanying claims.

1. An agricultural automation system for use in an agricultural area, comprising:
an elongate transport structure; and
a field robot movable along said elongate transport structure, said field robot being movable in at least one direction different from said movement along said elongate transport structure, said field robot including at least one implement carried thereby.

2. The agricultural automation system of claim 1, wherein said implement includes at least one of a tool and a sensor.

3. The agricultural automation system of claim 2, wherein said field robot includes at least one movable arm, and said implement is detachably coupled with one said arm.

4. The agricultural automation system of claim 2, wherein said implement includes at least one tool, each said tool being one of:
a soil probe;
a plant sampler; and
a clamp on plant pressure sensor.

5. The agricultural automation system of claim 2, wherein said implement includes at least one sensor, each said sensor being one of:
a crop sensor;
a soil sensor;
a weather sensor;
an imaging device; and
a plant bio-sensor.

6. The agricultural automation system of claim 1, including a stationary implement caddy carrying a plurality of said implements, said field robot interfacing with said implement caddy for coupling with at least one selected said implement.

7. The agricultural automation system of claim 1, wherein said field robot includes at least one of a wireless data communication link and a non-volatile memory.

8. The agricultural automation system of claim 1, wherein said field robot includes a wireless data communication link.

9. The agricultural automation system of claim 8, including a remote electrical processor communicating with said wireless data communication link.

10. The agricultural automation system of claim 8, wherein said wireless data communication link provides information associated with at least one said implement regarding at least one of soil conditions, crop health, insect damage to said crop, disease identification, atmospheric information, canopy temperature and effectiveness of chemical applications to said crop.

11. The agricultural automation system of claim 1, wherein said elongate transport structure forms part of one of an agricultural irrigation system and a plant support trellis.

12. The agricultural automation system of claim 1, including an agricultural irrigation system, said elongate transport structure carried by said irrigation system.

13. The agricultural automation system of claim 12, wherein said irrigation system comprises a center pivot irrigation system.

14. The agricultural automation system of claim 12, wherein said elongate transport structure comprises one of a track and a cable.

15. The agricultural automation system of claim 1, wherein said elongate transport structure is positioned in association with a crop canopy.

16. The agricultural automation system of claim 15, wherein said elongate transport structure is positioned above said crop canopy.

17. An agricultural automation system for use in an agricultural area, comprising:
an implement caddy carrying a plurality of implements,
an elongate transport structure; and
a field robot movable along said elongate transport structure, said field robot including an arm movable in at least one direction different from said movement along said elongate transport structure, said field robot interfacing with said implement caddy for coupling said arm with at least one selected said implement.

18. The agricultural automation system of claim 17, wherein said implement includes at least one of a tool and a sensor.

19. The agricultural automation system of claim 18, wherein said implement includes at least one tool, each said tool being one of:
a soil probe;
a plant sampler; and
a clamp on plant pressure sensor.

20. The agricultural automation system of claim 18, wherein said implement includes at least one sensor, each said sensor being one of:
a crop sensor;
a soil sensor;
a weather sensor;
an imaging device; and
a plant bio-sensor.

21. The agricultural automation system of claim 17, wherein said field robot includes a wireless data communication link.

22. The agricultural automation system of claim 21, including a remote electrical processor communicating with said wireless data communication link.

23. The agricultural automation system of claim 17, wherein said elongate transport structure forms part of one of an agricultural irrigation system and a plant support trellis.

24. A method of operating an agricultural automation system, comprising the steps of:
moving a field robot along an elongate transport structure in an agricultural area;
moving an implement carried by said field robot in at least one direction different from said movement along said elongate transport structure; and
performing an agricultural operation with said implement.

25. The method of operating an agricultural automation system of claim 24, wherein said implement comprises one of a tool and a sensor, and said agricultural operation comprises one of a work operation with said tool, and a sensing operation with said sensor.

26. The method of operating an agricultural automation system of claim 24, including the step of transmitting data from a wireless data communication link onboard said field robot to a remote electrical processor.
